(19) United States
(12) Patent Application Publication
(10) Pub. No.: US 2014/0269153 A1
(43) Pub. Date: Sep. 18, 2014

(54) CHEMICAL SOLUTION MIXING AND DISPENSING APPARATUS

(71) Applicant: NKD TECHNOLOGIES, LLC, West Jordan, UT (US)

(72) Inventor: Ronald Scott Wells, South Jordan, UT (US)

(73) Assignee: NKD Technologies, LLC, West Jordan, UT (US)

(21) Appl. No.: 13/831,579

(22) Filed: Mar. 15, 2013

(51) Int. Cl. B01F 5/12; B01F 15/04

(52) U.S. Cl. CPC B01F 5/12; B01F 15/0416
USPC 366/141; 137/565.23; 366/150.1; 366/152.1

(57) ABSTRACT

Example embodiments of the present invention provide a chemical solution mixing a dispensing system for making a customized chemical solution for industrial applications. For example, the embodiments of the present invention can include a chlorination system that mixes and then dispenses a chlorine solution into a water supply line for the treatment or sanitation of the water in the water supply line.

### TECHNICAL FIELD OF THE INVENTION

The present disclosure generally relates to various methods, devices, equipment and systems used to mix and dispense chemical solutions for a variety of industrial applications.

### BACKGROUND OF THE INVENTION

Many industries require the use of a chemical solution to accomplish an industrial purpose. Depending on the industrial application, the most efficient and effective way to provide the chemical solution may be to store the various chemical components that make up the chemical solution in a concentrated state, and then make the chemical solution on-site. Making a chemical solution on-site, as opposed to providing a pre-made chemical solution can save space, time and money. For example, many chemical solutions can be made from combining one or more solid components and one or more liquid components to make the required chemical solution.

Many industrial applications require large amounts of a chemical solution, and therefore, industry has made various attempts to automate the making and dispensing of chemical solutions. For example, the industry has made various attempts at automating the making of a chemical solution from one or more solid components and one or more liquid components. Although many of the past attempts have resulted in conventional systems and methods to make and dispense a chemical solution made from a solid component and a liquid component, the conventional systems and methods have several disadvantages.

One disadvantage, for example, is that conventional systems and methods result in an imprecise chemical solution. For example, some conventional systems use a large portion of a solid component, and then spray a liquid component onto the solid component. The resulting liquid chemical solution is then dispensed. This system and method leads to an inaccurate concentration of the solid component in the chemical solution. For example, although the amount of the liquid component may be controlled, the conventional system does not allow the amount of the solid component to be controlled. In particular, the rate at which the chemical component dissolves into the sprayed on liquid is variable and depends on many factors that change over time, for example the surface area of the solid component. Therefore, the resulting chemical solution can vary in concentration, resulting in unpredictable industrial outcomes.

Likewise, because conventional systems and methods do not allow the amount of the solid component to be controlled precisely, often times conventional systems and methods waste large portions of the solid component needlessly. For example, conventional systems may overuse the solid component, resulting in a higher operating cost of a particular industrial process.

Another disadvantage of conventional systems and methods is that conventional systems and methods require significant upkeep and maintenance. In particular, conventional systems and methods may result in the formation of a slurry or paste due to inaccurate mixing of the solid and liquid components. The slurry or paste may clog or destroy various pieces of equipment, and require costly maintenance, repair, and process downtime.

Furthermore, conventional systems and methods do not provide feedback on the amount of the solid component available to be used in making the chemical solution. As described above, conventional systems may use large portions of a solid component that are sprayed or washed over by a liquid component. The time in which the solid component is used may vary drastically based on many factors. Therefore, regular visual inspection of the status of the solid component is required to make sure that the system includes sufficient amounts of the solid component to make the necessary chemical solution.

Accordingly, there is a need for improved devices, systems and methods for automating the mixing and dispensing of chemical solutions.

### SUMMARY OF THE INVENTION

Example embodiments of the present invention provide a chemical solution mixing a dispensing system for making a customized chemical solution for a particular industrial application. For example, the embodiments of the present invention can include a chlorination system that mixes and then dispenses a chlorine solution into a water supply line for the treatment or sanitation of the water in the water supply line. In particular, example embodiments of the present invention provide a chemical solution mixing and dispensing system that automatically mixes a precise concentration of a chemical solution made from a solid component and a liquid component. In addition, the chemical solution mixing and dispensing system can accurately dispense the mixed chemical solution as required by the industrial application.

In one example embodiment, a system includes a solid component container that holds a solid component. In addition, the system includes a vacuum line having a first end and a second end. The first end of the vacuum line can be coupled to the solid component container. Moreover, the system can include a batch chamber coupled to the second end of the vacuum line. Furthermore, the system can include a vacuum pump, that when activated, creates an airflow from the solid component container through the vacuum line and into the batch chamber, the airflow being capable of moving a portion of the solid component from the solid component container to the batch chamber. A weight measurement device measures a change of weight of the solid component located in the solid component container as the airflow moves the portion of the solid component from the solid component container to the batch chamber.

In another example embodiment, a system includes a solid component dispensing subsystem. The solid component dispensing subsystem can include a solid component container and a solid component located with the solid component container. In addition, the system can include a vacuum pump that provides an airflow through the solid component container, the airflow capable of moving a portion of the solid component out of the solid component container.

In yet another example embodiment of the present invention, a method includes determining a requirement for an amount of a final chemical solution. The method further includes adding a known amount of a liquid component to a batch chamber based on the requirement for a final chemical solution. Moreover, the method can include adding a known amount of a solid component to the batch chamber and then mixing the liquid component and solid component to form a final chemical solution.

Additional features and advantages of the invention will be set forth in the description which follows, and in part will be obvious from the description, or may be learned by the practice of the invention. The features and advantages of the invention may be realized and obtained by means of the instruments and combinations particularly pointed out in the appended claims. These and other features of the present invention will become more fully apparent from the following description and appended claims, or may be learned by the practice of the invention as set forth hereinafter.

### BRIEF DESCRIPTION OF THE DRAWINGS

In order to describe the manner in which the above-recited and other advantages and features of the invention can be obtained, a more particular description of the invention briefly described above will be rendered by reference to specific example embodiments thereof which are illustrated in the appended drawings. Understanding that these drawings depict only typical implementations of the invention and are not therefore to be considered to be limiting of its scope, the invention will be described and explained with additional specificity and detail through the use of the accompanying drawings.

FIG. 1 illustrates a schematic overview of an example embodiment of an apparatus for making and dispensing a chemical solution;

FIG. 2 illustrates a schematic of an example embodiment of a vacuum system that may be used in an apparatus for making and dispensing a chemical solution;

FIG. 3 illustrates a schematic of an example embodiment of a batch chamber system for use with an apparatus for making and dispensing a chemical solution;

FIG. 4 illustrates a schematic of an example controller configuration for use with an apparatus for making and dispensing a chemical solution;

FIG. 5 illustrates and example method for making and dispensing a chemical solution; and

FIG. 6 illustrates an example apparatus for making and dispensing a chemical solution.

### DETAILED DESCRIPTION OF THE INVENTION

Example embodiments of the present invention provide a chemical solution mixing a dispensing system for making a customized chemical solution for a particular industrial application. For example, the embodiments of the present invention can include a chlorination system that mixes and then dispenses a chlorine solution into a water supply line for the treatment or sanitation of the water in the water supply line. In particular, example embodiments of the present invention provide a chemical solution mixing and dispensing system that automatically mixes a precise concentration of a chemical solution made from a solid component and a liquid component. In addition, the chemical solution mixing and dispensing system can accurately dispense the mixed chemical solution as required by the industrial application.

Example embodiments of the present invention provide several advantages over conventional systems and methods of making and dispensing a chemical solution made from one or more solid components and one or more liquid components. In particular, example embodiments of the present invention provide devices, systems and methods that can make and dispense a predictably accurate concentration of a chemical solution. In particular, example embodiments of the present invention provide systems and methods of automatically and accurately mixing a measured amount of one or more solid components with a known amount of one or more liquid components, thus resulting in a chemical solution with an accurate concentration.

Due to the accurate mixing of a measured amount of one or more solid components, almost no amount of the one or more solid components is wasted. Instead, the present invention provides an automatic measuring and mixing process that accurately and efficiently uses a solid component. Therefore, when compared to conventional systems and methods, example embodiments of the present invention reduce wasting chemical components, and in turn reduce the overall cost of producing the chemical solution.

In addition to the above advantages, example embodiments of the present invention provide systems and devices that require less maintenance compared to conventional systems. In particular, examples of the present invention provide a batch chamber that accurately and thoroughly mixes the various chemical components prior to dispensing the chemical solution. Due to the accurate measurement of the solid components, as well as the batch chamber mixing process, the chemical solution is accurately prepared in the batch chamber and solid components are unable to flow to other devices and mechanisms in the process where the solid components could cause damage or require maintenance.

In addition, and as mentioned above, example embodiments of the present invention accurately mix measured amounts of one or more solid components. Based on the accurately measured amounts of the one or more solid components, the system can log how much of a particular solid component is used, and by correlation, send an alert when an additional amount of the solid component needs to be added to the system. In this way, example embodiments of the present invention require less in process maintenance compared to conventional systems, increasing productivity and efficiency in making and dispensing the chemical solution.

The above and additional advantages of the present invention will be discussed further with respect to the Figures. For example, FIG. 1 illustrates a general overview schematic of an example chemical solution mixing and dispensing system 100. The chemical solution mixing and dispensing system 100 can be used for a variety of industrial processes. For example, the mixing and dispensing system can be used as a chlorination system to make and dispense a chlorine solution into a water supply for treatment of the water supply. Other examples include any process that requires a chemical solution to be made and dispensed for any industrial purpose, such as manufacturing, chemical treating, cleaning, or any other industrial application.

The schematic illustrated in FIG. 1 shows the general components of an example embodiment of the chemical solution mixing and dispensing system 100. For example, and as illustrated in FIG. 1, the chemical solution mixing and dispensing system can include a solid component container 102 that stores a solid component 104 to be used to make a chemical solution. In one embodiment, the solid component 104 is in a solid granular form (e.g., sand-like). In alternative embodiments, the solid component 104 may be in other forms, such as pellets or powders, for example.

The solid component container 102 can be placed on a weight measurement device 106 that measures the weight of the component container 102 and the solid component 104. Thus, as the solid component 104 is used, the amount of the solid component 104 used and the amount of the solid component 104 remaining can be determined, as will be explained further below. This allows the chemical solution mixing and dispensing system to accurately control the amount of the solid component 104 used to mix a chemical solution. In addition, the remaining amount of the solid component 104 can be determined, and the chemical solution mixing and dispensing system 100 can be configured to send an alert or message to an operator when more solid component 104 needs to be added to the system.

Coupled to the solid component container 102 is a first vacuum tube 108 that is coupled to a batch chamber 110, as illustrated in FIG. 1. As shown, the first vacuum tube 108 can be used to transport the solid component 104 from the solid component container 102 to the batch chamber 110. Once within the batch chamber 100, the solid component 104 can be mixed with other solid components and/or one or more liquid components to produce a chemical solution.

In order to facilitate the transport of the solid component 104 from the solid component container 102 to the batch chamber 110, a vacuum can be created within the batch chamber 110. For example, and as illustrated in FIG. 1, a second vacuum tube 112 can couple to the batch chamber 110 to a vacuum pump 130. In particular, the vacuum pump 130 creates a negative pressure though the second vacuum tube 112, which thereby creates a negative pressure within the batch chamber 110. The negative pressure causes a suction force to be exerted by way of the first vacuum tube 108, and thereby pulls the solid component 104 from the solid component container 102 to the batch chamber 110.

Also coupled to the batch chamber 110 is a liquid inlet line 114. The liquid inlet line 114 is used to deposit a liquid component 116. In one example embodiment, the liquid component 116 can be added to the batch chamber 100 prior to the solid component 104. In other examples, the liquid component 116 can be added after the solid component 104. Once both the solid component 104 and the liquid component 114 are added to the batch chamber 110, the solid component 104 and the liquid component form a batch solution 118. The batch solution 118 can then be processed. For example, the batch solution 118 can be stirred, agitated and/or processed in other ways for a predetermined amount of time that is required to create a final chemical solution 120.

As further illustrated in FIG. 1, after processing the batch solution 118 to create the final chemical solution 120, the final chemical solution 120 is transferred by way of a solution line 122 and stored in a solution tank 124. In one example embodiment, the solution tank 122 is sized to hold several batches, thus allowing the solution tank 124 to be a reservoir for the final chemical solution 120. Once in the solution tank 124, the final chemical solution 120 is ready to be dispensed for an industrial purpose. For example, the dispensing of the final chemical solution 120 can go through a dispensing line 126, and controlled by a pump 128, as illustrated in FIG. 1.

FIG. 1 illustrates one example of the chemical solution mixing and dispensing system 100 that can be used to mix a single solid component 104 and a single liquid component 116. In alternative embodiments, however, additional elements and devices can be added to the general system illustrated in FIG. 1 to provide for additional mixing and processing of various solution components. For example, the chemical solution mixing and dispensing system 100 can include two or more solid component containers 104, vacuums pumps 130, batch chambers 110, liquid inlet lines 114 and solution tanks 124. Therefore, consistent with the concepts described above, the chemical solution mixing and dispensing system 100 can be used to mix one or more solid components 104 with one or more liquid components 116.

In addition, the chemical solution mixing and dispensing system 100 can be used to create multiple (e.g., more than one) batch solutions 118 in multiple batch chambers 110. In the event that more than one batch solution 118 is created, the chemical solution mixing and dispensing system 100 can be configured to either combine the different batch solutions 118 into a single final chemical solution 120 in a single storage tank 124, or alternatively, more than one final chemical solution 120 can be produced in a corresponding number of storage tanks 124.

As discussed above, the chemical solution mixing and dispensing system 100 can be used in a variety of industrial applications that require the making and dispensing of a chemical solution. Although the industrial applications vary widely for the chemical solution mixing and dispensing system 100, additional details related to the function and components of the chemical solution mixing and dispensing system 100 will be explained in view of a particular application. In particular, FIGS. 2 through 5 will be explained in more detail with respect to a chemical solution mixing and dispensing system 110 that is used to make and dispense a chlorine solution. For example, the chemical solution mixing and dispensing system 100 can be a chlorination system that is used to dispense an accurate amount of a chlorine solution into a water supply to sanitize or otherwise treat the water supply.

The chemical solution mixing and dispensing system 100 can be described with reference to two or more subsystems. For example, the chemical solution mixing and dispensing system 100 can include a solid component dispensing subsystem 132 and a batch mixing and solution dispensing subsystem 152. The solid component dispensing subsystem 132 can be used to dispense an accurate amount of solid component 104 into the batch chamber 110. For example, the solid component dispensing subsystem 132 can be used to dispense an accurate amount of a solid chlorine component into the batch chamber 110. The batch mixing and solution subsystem 152 can be used to mix the batch solution 118 and dispense the final chemical solution 120. For example, the batch mixing and solution subsystem 152 can be used to mix a solid chlorine component and water as a batch solution, which ultimately produces a final chlorine solution to be dispensed into a water supply to treat the water supply.

FIG. 2 illustrates an example embodiment of a solid component dispensing subsystem 132. As illustrated in FIG. 2, and as generally explained above with reference to FIG. 1, the solid component dispensing subsystem 132 can include a solid component container 102 that contains an amount of a solid component 104. As shown in FIG. 2, the solid component container 102 can take the form of a packaging container or bucket (see also FIG. 6). For example, the solid component container 102 can be the packaging container used to ship the solid component 104, and therefore, the packaging container can be seamlessly and easily integrated with the solid component dispensing subsystem 132. Therefore, when the solid component 104 is depleted from the solid component container 102, an operator can simply exchange the empty solid component container 102 for a full solid component container 102. In alternative embodiments, the solid component container 102 can be a permanent structure within the solid component dispensing subsystem 132. For example, the solid component container 102 can be a hopper that is configured to be refilled when the solid component 104 is exhausted.

The solid component container 102 can be a variety of sizes and configured to hold various amounts of the solid component 104. In one example embodiment, the solid component container 102 can contain about fifty pounds of the solid component 104. In alternative embodiments, however, the solid component container 102 can be configured to contain less than about five pounds or more than about 2000 pounds. For example, the solid component container 102 can be configured to contain very large volumes of the solid component 104 such that there is less need to refill the solid component 104 to the solid component dispensing subsystem 132.

In addition to containing varying amounts of the solid component 104, the solid component container 102 can have various geometric configurations. For example, and as illustrated in FIG. 2, the solid component container 102 can have a substantially cylindrical geometric configuration (e.g., bucket-like). Alternatively, the solid component container 102 can have a cubic or any other geometric configuration that may be required to maximize utility of the solid component container 102.

As further illustrated in FIG. 2, the solid component container 102 can include an air vent 134. The air vent 134 can vary from one embodiment to the next. In one embodiment, and as shown in FIG. 2, the air vent 134 can be located on a top portion of the solid component container 102. The location of the air vent 134 on the solid component container 102 can vary depending on the airflow characteristics desired, and on the configuration of the solid component container. In addition, the air vent 134 can have various sizes depending on the amount of airflow that is desired to flow through the tank, and at what flow rate the air is needed flow to effectively collect granules of the solid component 104. For example, the cross-sectional area of the air vent 134 can be about one square inch, but the cross-sectional area of the air vent 134 can be larger or smaller depending on the desired airflow characteristics. In addition, the solid component container 102 may have more than one air vent 134 to facilitate various airflow patterns that may be desired to effectively collect the solid component 104.

The purpose of the air vent 134 is to allow airflow through the interior of the solid component container 102 to collect and transport the solid component 104. In particular, and as shown FIG. 2, vacuum pump 130 can create a negative air pressure to establish an airflow that transports the solid component 104 from the solid component container 102 to the batch chamber 110. For example, a control unit 138 can activate the vacuum pump 130 and establish an airflow, as indicated by the arrows that pass through the air vent 134, the solid component container 102, the first vacuum tube 108, the batch chamber 110, the second vacuum tube 112, and the vacuum pump 130.

As the airflow moves through the solid component container 102, the airflow collects granules 140 of the solid component 104, as illustrated in FIG. 2. Thus, the airflow becomes the transportation mechanism to transport the solid component 104 from the solid component container 102 to the batch chamber 110. For example, the solid component 104 is transported from the solid component container 102, through the first vacuum tube 108, and into the batch chamber 110. As illustrated in FIG. 2, once the granules 140 enter the batch chamber 110, substantially all of the granules 140 become trapped in the batch solution 118. For example, the batch solution 118 is at a level in which the airflow pattern deposits substantially all of the granules 140 within the batch solution 118.

In one example embodiment, the first vacuum tube 108 is connected to a funnel 105 that rests in the bottom of the solid component container 102, as illustrated in FIG. 2. The first vacuum tube 108 can have one or more gates defined by the first vacuum tube 108 and the funnel 105 that allow the granules 140 to enter the first vacuum tube 108. In addition the funnel 105 directs the granules 140 toward the one or more gates with gravity, because the granules slide down the funnel 105 surfaces and towards the gates as granules 140 are transported through the first vacuum tube 108 to the batch chamber 110.

In order to measure the amount of the solid component 104 that is deposited into the batch chamber 110, the solid component dispensing subsystem 132 can include a weight measurement device 106, as illustrated in FIG. 2. The weight measurement device 106 is configured to measure the weight of the solid component container 102 and the solid component 104. As the granules 140 of the solid component 104 are transported from the solid component container 102 to the batch chamber 110, the weight of the solid component container 102 and the solid component 104 decreases by the amount of the granules 140 of the solid component 104 that is removed from the solid component container 102. By tracking this decrease in weight, a precise amount of the solid component 104 can be automatically deposited into the batch chamber 110 for the purpose of making an accurate concentration of the final chemical solution 120 (as will be explained further below).

The weight measurement device 106 can be a digital or analog scale that is capable of providing substantially instantaneous weight measurement readings as an output signal from the weight measurement device 106. For example, and as illustrated in FIG. 2, the weight measurement device 106 can provide a weight measurement reading via a weight measurement communication wire 136. In particular, and as illustrated in FIG. 2, the weight measurement communication wire 136 can couple to an output on the weight measurement device 106 and to an input on the control unit 138. Thus, the weight measurement device 106 can provide a substantially instantaneous weight measurement reading to the control unit 138.

In addition to the input of the weight measurement communication wire 136, the control unit 138 can include outputs for a vacuum pump communication wire 142 and a flush valve communication wire 144. Thus, the control unit 138 can control various devices of the solid component dispensing subsystem 132 to perform a process or cycle. For example, FIG. 2 illustrates that the control unit 138 includes a processor 146 that can execute instructions as well as control a communications module that has an input and output that can send and receive communication signals to and from various devices that are part of the solid component dispensing subsystem 132.

In addition, the control unit 138 includes memory with software 148. The memory can store the software, which can include an operating system as well as executable instructions which comprise a program that allows the control unit 138 to electronically control, communicate, monitor, report and perform various operations within the solid component dispensing subsystem 132. In addition, the memory can store data, as indicated in FIG. 2. The specific processes that the control unit 138 performs will be discussed in more detail with respect to FIG. 4 below.

In addition to communicating with the weight measurement device 106, the control unit 138 can be coupled to a flush valve 150 through a flush valve communication wire 144. As illustrated in FIG. 2, the flush valve 150 can be installed on the first vacuum tube 108. For example, the flush valve 150 can be installed after a lower portion 108a and prior to an upper portion 108b of the first vacuum tube 108. The flush valve is used to flush the first vacuum tube 108 of the granules 140 such that substantially no granules 140 are left within the first vacuum tube 108. Therefore, the flush valve 150 increases the accuracy of the solid component dispensing subsystem 132 by making sure that substantially the same weight of granules 140 that were removed from the solid component container 102 are deposited in the batch chamber 110.

In one example embodiment the flush valve 150 can be a solenoid operated slide valve that in its gravity biased position blocks the atmospheric airway in the first vacuum tube 108 to the batch chamber 110. When in an energized position, the slide valve opens and provides an airway from the atmosphere through the upper portion 108b of the first vacuum tube 108 to the batch chamber 110, as illustrated in FIG. 2. Thus, the flush valve 150 uses atmosphere air to flush any remaining granules 140 from the upper portion 108b of the first vacuum tube 108. Due to the open airway from the atmosphere, the airflow is limited from the solid component container 102, and thus the transportation of the granules 140 ceases upon activation of the flush valve 150.

In another example, the flush valve 150 can be a three-way solenoid valve that in its spring biased position provides an airway from the solid component container 102 through the first vacuum tube 108 to the batch chamber 110. When in an energized position, the three-way valve shuts off the airway from the solid component container, and provides an airway from the atmosphere through the upper portion 108b of the first vacuum tube 108 to the batch chamber 110, as illustrated in FIG. 2. Thus, the flush valve 150 uses atmosphere air to flush any remaining granules 140 from the upper portion 108b of the first vacuum tube 108.

The flush valve 150 can be positioned anywhere along the first vacuum tube 108. For example, FIG. 2 illustrates that the flush valve 150 can be positioned about at a midpoint within the first vacuum tube 108. Alternatively, the flush valve 150 can be positioned closer to the solid component container 102 such that the lower portion 108a of the first vacuum tube 108 is minimized. Minimizing the length of the lower portion can reduce the amount of granules 140 that fall back into the solid component container 102 after the flush valve is activated.

The above described devices and functions can be combined to provide a solid component dispensing process. In one example embodiment, the solid component dispensing process begins with the control unit 138 activating the vacuum pump 130 through the vacuum pump communication wire 142. The vacuum pump 130 provides an airflow starting at the air vent 134 and extending through the vacuum pump 130, as indicated by the flow arrows shown in FIG. 2. The airflow transports or carries granules 140 from the solid component container 102 to the batch container 110. The weight measurement device 106 measures the decrease in weight of the solid component 104 as the granules 140 leave the solid component container 102, and the weight measurement device 106 communicates the decrease in weight of the solid component 104 to the control unit 138.

Upon a desired amount of decrease in weight of the solid component 104, the control unit 138 energizes the flush valve 150 through flush valve communication wire 144. While the flush valve 150 is energized, the control unit 138 continues to activate the vacuum pump 130 such that an airflows from the atmosphere starting at the flush valve 150 and continuing through the vacuum pump 130. The resulting airflow pattern flushes the upper portion 108b of the first vacuum tube 108 of substantially all granules 140 of the solid component 104, and provides that substantially all of the measured granules 140 are deposited in the batch chamber 110.

After a predetermined amount of time of air flowing from the atmosphere through the flush valve (e.g., between about 1 second and about 5 seconds), the control valve deactivates the vacuum pump 130 through vacuum pump communication wire 142. The control unit 138 can verify that the vacuum pump 130 is no longer drawing any airflow (e.g., the control unit 138 can be programmed to wait a period of time that confirms no airflow that may result from the vacuum pump 130 winding down after deactivation). The control unit 138 then de-energizes the flush valve 150 to complete the solid component dispensing process through the solid component dispensing subsystem 132.

As mentioned above, the solid component dispensing subsystem 132 can be used in correlation with a batch mixing and solution dispensing subsystem 152. FIG. 3 illustrates one example of the batch mixing and solution dispensing subsystem 152. As illustrated in FIG. 3, the batch mixing and solution dispensing subsystem 152 can include the control unit 138. The control unit 138 can be the same control unit 138 as described with respect to the solid component dispensing subsystem 132. As described above, the control unit 138 includes a processor 146 that can execute instructions as well as control a communications module that has an input and output that can send and receive communication signals to and from various devices that are part of the solid component dispensing subsystem 132. In addition, the control unit 138 includes memory with software 148. The memory can store the software, which can include an operating system as well as executable instructions which comprise a program that allows the control unit to electronically control, communicate, monitor, report and perform various operations within the solid component dispensing subsystem 138. In addition, the memory can store data received from various devices and export the data for analysis.

The batch mixing and solution dispensing subsystem 152 includes the batch chamber 110 for mixing the batch solution 118. In one example embodiment the batch chamber 110 has a substantially cubic geometric configuration, as illustrated in FIG. 3. In alternative embodiments, the batch chamber can have alternate geometric configurations, such as spherical or cylindrical.

In addition to various geometric configurations, the batch chamber 110 can have various volumes. For example, the volume of the batch chamber 110 can be about one cubic foot. In alternative embodiments, the volume of the batch chamber 110 can be larger or smaller depending on the amount of batch solution 118 that a process requires in a single batch. In addition to the various volumes, the batch chamber can be made from various materials. In one example, the batch chamber 110 is made from a transparent plastic, such as plexiglass or similar type of material. In alternative embodiments, the batch chamber can be made from other plastics, glass, metal or other materials depending on the nature of the chemical components used to make the batch solution 118. In any event, the material of the batch chamber 110 should be chemically inert with the chemical components mixed within the batch chamber 110.

As illustrated in FIG. 3, and as described in detail with respect to FIG. 2, the first vacuum tube 108 and second vacuum tube 112 are coupled to the batch chamber 110 to facilitate depositing the solid chemical component 104. In addition, the liquid inlet line 114 is coupled to the batch chamber 110. The liquid inlet line 114 carries the liquid component 116. In one example embodiment the liquid component 116 is water. For example, when making a chlorine solution, the solid component 104 is a solid form of chlorine and the liquid component 116 is water. In other example embodiments, the liquid component 116 can be various other liquid chemicals needed to make various other chemical solutions.

The liquid inlet line 114 can be equipped with various devices to help control the input of the liquid component 116 in to the batch chamber 110. For example, and as illustrated in FIG. 3, the liquid inlet line 114 can be equipped with a first pressure gauge 154 that measures the inlet pressure of the inlet liquid line 114. The first pressure gauge 154 can be in communication with the control unit 138, and the control unit 138 can be programmed to monitor the pressure on the inlet and react (e.g., shut down the system and/or send an error message) if the pressure of the inlet rises above, or drops below, predetermined values.

In addition the liquid inlet line 114 can include a pressure regulator 156 to regulate the pressure that enters the chemical solution mixing and dispensing system 100, as shown in FIG. 3. The pressure regulator can be set to a predetermined value to regulate the pressure within the liquid inlet line 114. As illustrated in FIG. 3, a second pressure gauge 158 can be located after the pressure regulator 156 to provide a pressure reading after the pressure regulator 156 to make sure the pressure regulator 156 is functional. As with the first pressure gauge 154, the second pressure gauge 158 can be in communication with the control unit 138. The control unit 138 can be programmed to monitor the liquid component 116 pressure after the pressure regulator 156 and react (e.g., shut down the system and/or send an error message) if the second pressure gauge rise above, or drops below, predetermined values.

FIG. 3 further illustrates that the liquid inlet line 114 can further include a liquid valve 160. The liquid valve 160 is used to control the flow of the liquid component 116 to the batch chamber 110. In one example embodiment, the liquid valve 160 can be a solenoid valve that is normally closed (e.g., spring biased closed). The control unit 138 can be programmed to energize the solenoid valve at an appropriate time to open the liquid valve 160 and allow the liquid component 116 to flow past the liquid valve 160 and into the batch chamber 110. For example, and as illustrated in FIG. 3, the control unit can send a signal through a liquid valve communication wire 162 to control the liquid valve 160.

In order to obtain a measured amount of the liquid component 116, the batch chamber 110 can be equipped with a first sensor 164 that is connected to the control unit 138 with a first sensor control wire 166. The first sensor 164 can be positioned at a height within the batch chamber 110 such that the first sensor sends a signal to the control unit 138 when a particular volume of liquid component 116 has been added to the batch chamber 110. For example, the first sensor 164 can send a signal through the first sensor communication wire 166 when the batch chamber 110 is filled with about one cubic foot of the liquid component 116.

The first sensor 164 can be one of various types of sensors. In one example embodiment, the first sensor 164 can be described as a mechanical lift contact sensor. The mechanical lift contact sensor includes a flotation portion on the end of a lever. As the liquid level rises within the batch chamber 110, the liquid will eventually contact the floatation portion and cause the floatation portion to rise with the liquid level. The rise of the floatation portion will cause the lever to rotate, which causes an electrical contact to be made, thus sending a signal through the first sensor communication wire 166 to the control unit 138. Other level sensors can be used that provide the same or similar results.

Alternatively, or in addition to the first sensor 164, the amount of liquid component 116 can be measured with a flow meter 168. For example, as illustrated in FIG. 3, the flow meter 168 can be positioned between the liquid valve 160 and the batch chamber, and thus can measure the volume of the liquid component that passes through the liquid valve 160 and into the batch chamber 110. The flow meter 168 can be any type of flow meter known in the industry. For example, the flow meter 168 can be a differential pressure, velocity, positive displacement, or mass flow meter. As illustrated, the flow meter 168 can be connected to the control unit 138 through the flow meter communication wire 170 to provide the amount of liquid component 116 that passes through the flow meter 168 as an input to the control unit 138.

In the event of an overflow malfunction, the batch chamber 110 can be equipped with an overflow pipe 172, as illustrated in FIG. 3. For example, the overflow pipe 172 can be a pipe that has an inlet positioned at a height within the batch chamber 110 that if reached would be cause for concern (e.g., the first level 164 sensor and/or the flow meter 168 has malfunctioned). In the event that the liquid level reaches the inlet of the overflow pipe 172, the liquid will flow through the overflow pipe 172 and into an overflow column 174 that will collect the over flow liquid component 116.

The overflow column 174 can include an overflow sensor 176. The overflow sensor 176 is connected to the control unit 138 with an overflow sensor communication wire 178. The overflow sensor 176 is tripped when the liquid level in the overflow column 174 reaches the overflow sensor 176. Upon sensing the overflow liquid, the overflow sensor 176 can send a signal to the control unit 138. The control unit 138 can be programmed to execute one or more commands upon receiving a signal from the overflow sensor 176. For example, the control unit 138 can turn off and/or close all devices in order to stabilize the chemical solution mixing and dispensing system 100. In addition, the control unit 138 can create and/or transmit an error message indicating that the overflow sensor 176 has been tripped.

Assuming there is no overflow condition, the batch chamber 110 can be filled with known amounts of the liquid component 116 and the solid component 104 to form the batch solution 118. In one example embodiment, the batch solution 118 can be further processed to properly mix the solid component 104 and liquid component 118 (e.g., dissolve the solid component 104 into the liquid component 116 to form a homogenous solution). In one example embodiment, the batch chamber 110 can be coupled to a mix pump 182 and eductor 180 to assist in the processing of the batch solution 118. For example, the mix pump 182 and eductor 180 can be a device that is configured to mix the batch solution 118 until the solid component 104 is substantially or completely dissolved in the liquid component 116 to form the final chemical solution 120.

The configuration of the mix pump 182 and eductor 180 can vary from one embodiment to the next. For example, and as illustrated in FIG. 3, the mix pump 182 recirculates the batch solution 118 through eductor 180, providing a mixing motion within the batch solution 118. In particular, the mix pump 182 can continuously draw the batch solution 118 through a mix pump inlet pipe 183a. The mix pump 182 then pumps the batch solution 118 back to the batch chamber 110 through mix pump outlet pipe 184a and through the eductor 180. The eductor 180 can be configured with spray nozzles that create a mixing flow motion as the batch solution 118 goes through the eductor 180. In addition, the eductor 180 can spray the batch solution 118 into the batch solution 118 in the batch chamber 110, and thereby create a mixing motion within the batch chamber 110.

As further illustrated in FIG. 3, the mix pump 182 can be coupled to the control unit 138 with a mix pump communication wire 184. The control unit 138 is capable of sending a signal to the mix pump 182 to control the mix pump 182 through the motor communication wire 184, and thus control the mixing flow pattern through the eductor. In one example embodiment, the mix pump 180 can have a single speed motor that is either off or on. Alternatively, the mix pump 182 can have a variable speed motor.

Once the batch solution 118 is fully processed, the batch solution 118 becomes the final chemical solution 120. In one example embodiment, once the final chemical solution 120 is prepared, the final chemical solution 120 is removed from the batch chamber 110 and placed into the solution tank 124. As illustrated in FIG. 3, the batch chamber 110 can be coupled to the solution tank by way of a solution line 122. The final chemical solution 120 can drain from the batch chamber 110 to the solution tank 124 for storage until the final chemical solution 120 is dispensed for the industrial purpose.

In order to move the final chemical solution 120 from the batch chamber 110 to the solution tank 124, the solution line 122 can further include a solution line valve 186. In one example embodiment, the solution line valve 186 is a solenoid valve that is in the normally closed position (e.g., spring biased to the closed position). As further illustrated in FIG. 3, the solution line valve 186 can be coupled to the control unit 138 with a solution line valve communication wire 188. Therefore, the control unit 138 can send a signal to the solution line valve 186 through the solution line valve communication wire 188, which energizes or otherwise causes the solution line valve 186 to open.

Upon opening, the final chemical solution 120 can drain from the batch chamber 110 to the solution tank 124. In one embodiment, the final chemical solution 120 is initially pulled through the solution line 122, which thereby creates a siphon action causing the final chemical solution 120 to continue to drain from the batch chamber 110. As illustrated in FIG. 3, the solution line 122 is configured such that the inlet of the solution line 122 is facing the floor of the batch chamber 110. This configuration allows for the complete draining of the batch chamber 110. However, the orientation of the inlet of the solution line 122 can vary from one embodiment to the next depending on the desired function of the solution inlet line 122.

During the process of draining the final chemical solution 120 from the batch chamber 110 to the solution tank 124, a second sensor 190 can measure the level within the chamber to indicate when a predetermined amount of the final chemical solution 120 is removed from the batch chamber 110. For example, and as illustrated in FIG. 3, the second sensor 190 can be coupled to the control unit 138 through a second sensor communication wire 192. In one example embodiment, the second sensor 190 is configured to send a signal through the second sensor communication wire 192 when substantially all of the final chemical solution 120 has been removed from the batch chamber 110. In alternative embodiments, the second sensor 190 can be configured or positioned to send a signal to the control unit based on a variety of liquid levels within the batch chamber 110.

Once the final chemical solution 120 is within the solution tank 124, the final chemical solution 120 is ready to be dispensed for the particular industrial purpose. For example, and as mentioned above, the final chemical solution 120 can be a chlorine solution with a particular concentration of chlorine that is meant to be added to a main water supply in order to treat or sanitize the water supply.

As illustrated in FIG. 3, the solution tank 124 can have a variety of features. For example, the solution tank 124 can have a variety of geometric configurations as well as sizes. In one example embodiment, the solution tank 124 has a substantially cylindrical configuration; however, the solution tank 120 can have any geometric configuration as required by the particular industrial application. Further more, the volume of the final chemical solution 120 that the solution tank 124 can hold can vary from one embodiment to the next. Generally, the solution tank 124 holds a larger volume compared to the batch tank 110. In one example embodiment, the solution tank 124 can hold about thirty gallons of the final chemical solution 120. In alternative embodiments, the volume of the solution tank 124 can be larger or smaller. Moreover, the solution tank 124 can be made of a variety of materials, for example, the solution tank 124 an be made from plastic, metal, or other suitable materials depending on the nature of the final chemical solution 120.

In addition to various physical characteristics, the solution tank 124 can include an overflow drain 192 that is positioned and configured to remove the final chemical solution 120 in the event that the solution tank 124 exceeds capacity. For example, and as illustrated in FIG. 3, the over flow drain 192 can be positioned near the top portion of the solution tank 124 and be configured to carry the over flow final chemical solution 120 to a drain area that will collect the overflow material and contain any damage potential form the excess final chemical solution 120. For example, the overflow drain 192 can be coupled to the overflow column 174, as illustrated in FIG. 3.

Moreover, and as illustrated in FIG. 3, the overflow drain 192 can be positioned within the solution tank 124 such that the overflow drain 192 inlet is about four inches from the bottom of the solution tank 124. Thus, in normal operating conditions, the inlet of the overflow drain is submerged and prevents fumes from exiting the solution tank through the overflow drain 192.

In addition to the overflow drain 192, the solution tank 124 can include a solution tank level sensor 194. The solution tank level sensor 194 can be positioned and configured to determine the level of the final chemical solution 120 within the solution tank 124. For example, and as illustrated in FIG. 3, the solution tank level sensor 194 can be coupled to the control unit 138 though a solution tank level sensor communication wire 196. In one example embodiment, the solution tank level sensor 194 is configure to send a signal to the control unit 138 in the event the level of the final chemical solution 120 exceeds a certain level (e.g., when the solution tank 124 is full or when the solution tank 124 is in an overflow condition).

As was briefly discussed above with reference to FIG. 1, and as further shown in FIG. 3, the solution tank 124 can include a dispensing line 126 positioned and configured to dispense the final chemical solution 120 for the industrial application. For example, the dispensing line 126 can be located near the bottom portion of the solution tank 124. In alternative embodiments, the dispensing line 126 can be located in alternative places so long as the inlet of the dispensing line 126 is in contact with the final chemical solution 120 such that the final chemical solution 120 can be dispensed through the dispensing line 126.

In one example embodiment, illustrated in FIG. 3, the dispensing line 126 can include a pump 128. The pump 128 can be connected to the control unit 138. In particular, the pump 128 can receive an input signal from the control unit 138 through a pump input communication wire 198. For example, the control unit 138 can send a signal through the pump communication wire 198 to control the pump 128, and therefore, control the amount of the final chemical solution 120 dispensed.

In addition to the input signal, the pump 128 can be cable of sending an output signal to the control unit 138 through a pump output communication wire 200. For example, the pump 128 can be configured to send a signal through the pump output communication wire 200 to the control unit 138 that provides data feedback on the amount of the final chemical solution 120 dispensed through the pump 128. The control unit 138 can save, store, and use the data output from the pump 128 as a variable in operating the chemical solution mixing and dispensing system 100.

As mentioned above, an example application of the chemical solution mixing and dispensing system 100 is to make a chlorine solution for the treatment of a water supply. In the chlorination application, as well as others, it can be useful to provide an industrial application input to the control unit 138 so that the control unit 138 can control the chemical solution mixing and dispensing system 100 based on the industrial application.

For example, and as illustrated in FIG. 3, a chlorination process can include dispensing the final chlorine solution (e.g., the final chemical solution 120) into a water supply line 202. In particular, the dispensing line 126 can be coupled to the water supply line 202 in order to facilitate the dispensing of the final chlorine solution into the water supply line 202. In order to dispense the proper amount of the final chlorine solution, a water supply flow meter 204 can be placed on the water supply line 202 in order to detect the amount of water flowing through the water supply line 202. In general, the higher the flow rate of water through the water supply flow meter 204, the more of the final chlorine solution will be dispensed into the water supply line 202.

The water supply flow meter 204 can be coupled to the control unit through a water supply flow meter communication wire 206, as illustrated in FIG. 3. Thus, the water supply flow meter 204 can send a signal through the water supply flow meter communication wire 206 to the control unit 138 that provides the control unit 138 with the flow rate through the water supply line 202. The control unit 138 can use the flow rate through the water supply line 202 to calculate the rate at which to dispense the final chlorine solution into the water supply line 202.

Although the devices and systems described above with references to FIGS. 1 through 3 can be used in a variety of ways to mix and dispense a chemical solution, FIG. 4 will be used to explain one example embodiment of a process that the chemical solution mixing and dispensing system 100 can perform. In particular, FIG. 4 illustrates an example embodiment of the control unit 138 with an example connection arrangement with the various devices explained above with references to FIGS. 1 through 3. As noted above, the control unit 138 includes a processor 146, memory with software 148, and a communications module 149 having an input and an output. The memory is also capable of storing data that is received from the various devices, or the data can be programmed and saved to the memory for the control unit 138 to use during the process.

In one example embodiment, the method and/or process of mixing and dispensing a chemical can begin with the control unit 138 receiving a signal to start the process of mixing additional chemical solution. For example, the control unit 138 can receive a signal from the solution tank level sensor 194 that indicates the level in the solution tank 124 has reached a level that additional final chemical solution is required.

In an alternative embodiment, the control unit 138 can have saved in the memory 148 the amount of the final chemical solution 120 in the solution tank 124 based on the number of batch solutions 118 that have been processed. In addition, the control unit 138 can have stored in the memory the amount of the final chemical solution 120 that has been dispensed through the pump 128. Therefore, the control unit can be programmed to calculate the amount of the final chemical solution 120 stored in the solution tank 124 by subtracting the amount of the final chemical solution 120 that has been dispensed from the amount of the final chemical solution 120 that has been made.

In particular, the control unit 138 can be programmed to store a volume unit that is produced for every batch of batch solution 118 mixed. For example, the control unit 138 can store the volume unit of one cubic foot batch of batch solution 118 that is deposited into the solution tank 124. The control unit 138 can count how many batches have been processed, and therefore, the control unit 138 can calculate a total amount of final chemical solution made. Likewise, because the control unit 138 is controlling the pump 128 that dispenses the final chemical solution 120, the control unit can calculate the total amount of the final chemical solution 120 dispensed, or alternatively, the pump 128 can provide a volume dispensed feedback to the control unit 138. Additional or alternative input and outputs can be used to calculate the amount of the final chemical solution 120 in the solution tank 124.

Therefore, the method of mixing and dispensing a chemical solution can begin by the control unit 138 calculating and/or receiving a signal that identifies the amount of the final chemical solution 120 stored in the solution tank 124. The control unit 138 can then compare the amount of the final chemical solution 120 with a baseline amount that has been selected by the operator. If the actual amount of the final chemical solution 120 is below the baseline amount, for example, the control unit 138 can be programmed to initiate the process to make another batch.

Upon initiating the process to make another batch, the control unit 138 can send an output signal to the liquid valve 160 that opens the liquid valve 160, as illustrated in FIG. 4. Upon opening the liquid valve 160, the liquid component 116 begins to flow into the batch chamber 110. The control unit 138 keeps the liquid valve open until the control unit receives a signal that a desired amount of liquid component 116 is deposited within the batch chamber. For example, the control unit 138 can receive an input signal from the first sensor 164, as illustrated in FIG. 4, when the liquid component 118 level has reached a desired level (e.g., the desired level within the batch chamber 110 is a known volume). Alternatively, or in addition to, the control unit 138 can monitor an input signal from the flow meter 168 to know when the desired amount of liquid component 118 has flowed past the flow meter 168, and thus has been deposited into the batch chamber 110.

Upon determining that the desired amount of the liquid component 118 has been deposited into the batch chamber 110, the control unit 138 can send a signal (or cease sending a signal) to the liquid valve 160 in order to close the liquid valve 160 and stop the flow of the liquid component 116 into the batch chamber.

The control unit 138 can then proceed to further execute instructions that result in a predetermined amount of the solid component 104 being deposited into the batch chamber 110. For example, the control unit 138 can execute instructions that activates the solid component dispensing subsystem 132 described above with respect to FIG. 2. The solid component dispensing subsystem 132 can commence by the control unit 138 sending an output signal to activate the vacuum pump 130, as illustrated in FIG. 4. Upon activation, the vacuum pump 130 creates the airflow described with respect to FIG. 2, and granules 140 of the solid component 104 are carried by the airflow into the batch chamber 110 and trapped within the liquid component 118 that had previously been deposited within the batch chamber 110.

As granules 140 of the solid component 104 leave the solid component container 102, the weight measurement device 106 measures the decrease in the weight of the amount of the solid component 104 within the solid component container 102. The control unit 138 can receive an input signal from the weight measurement device 106, as illustrated in FIG. 4. The input signal from the weight measurement device 106 communicates the decrease in weight to the control unit 138. The control unit 138 can monitor the decrease in weight and match the decrease to a desired amount of solid component 104 to mix with the liquid component 116. For example, the desired amount of solid component 104 can be a pre-programmed amount, or alternatively, can be a calculated amount based on the exact amount of liquid component added to the batch chamber 110.

Next, upon the control unit 138 matching the decrease in weight of the solid component 104 with the amount of the solid component desired to be deposited into the batch chamber, the control unit 138 can send an output signal to the flush valve 150 that causes the flush valve 150 to change the airflow pattern from flowing through the solid component container 102 to flowing from the atmosphere, as explained above with respect to FIG. 2. Meanwhile, the control unit continues to activate the vacuum pump 130, causing all or substantially all of the granules 140 to be flushed from the first vacuum tube 108.

The control unit 138 can execute instructions that continue flushing the first vacuum tube 108 for a predetermined amount of time to allow for the flushing of the first vacuum tube 108. Once the predetermined amount of time expires, the control valve can send an output signal (or cease to send a signal) such that the vacuum pump 130 deactivates. In addition, the control unit 138 can de-energize the flush valve 150, thus returning the flush valve 150 to the pre-energized state.

At this point in the process, the chemical solution mixing and dispensing system 100 has successfully combined the solid component 104 with the liquid component 116 into a batch solution 118 in the batch chamber 110. The control unit 138 can then execute instructions to send an output signal to the motor 182 to initiate the agitator 180 within the batch chamber 110. In one example, the control unit 138 is programmed to run the agitator 180 for a defined period of time. For example, the control unit 138 can be programmed to run the agitator 180 for a period of time of about two to three minutes. The time period may vary depending on the nature of the chemical solution, but in any event the time period allows the solid component 104 and the liquid component 116 to be mixed properly (e.g., form a substantially homogeneous solution). After the expiration of the time period, the control unit 138 can send a signal to the motor 182 (or cease to send a signal) such that the motor 182 deactivates the agitator 180.

After the control unit 138 deactivates the agitator, the batch chamber 110 now contains a known volume of the final chemical solution 120. The control unit 138 can proceed to execute instructions that send an output signal to the solution line valve 186 causing the final chemical solution 120 to drain from the batch chamber 110 and into the solution tank 124. The batch chamber 110 drains until substantially all of the final chemical solution 120 is drained from the batch chamber 110. For example, and as illustrated in FIG. 4, the control unit 138 can receive an input signal from the second sensor 190 when the second sensor 190 senses that substantially all of the final chemical solution 120 is removed from the batch chamber 110. The control unit 138 can then update a data table by determining the new volume of the final chemical solution 120 stored in the solution tank 124.

Next, or concurrent with the batch process, the control unit 138 receives an input signal from the water supply flow meter 204 indicating the flow rate within the water supply line 202, and calculates based off of an equation or data table, the rate at which the final chemical solution 120 needs to be added to the water supply line 202. The control unit 138 then sends an output signal to the pump 128 to dispense the final chemical solution 120 at the required rate. The process then can repeat as the control unit 138 continues to monitor the level of the final chemical solution 120 within the solution tank 124 to ensure that there is an always a sufficient amount of the final chemical solution 120 available for the industrial application.

In order to match the exact concentration of the final chemical solution 120 for dosing purposes and calibrating the pump 128 output, a calibration column can be built into the dispensing line 126. The calibration column allows the operator to measure the concentration of the final chemical solution, and then enter this concentration into the control unit 138. The control unit 138 can then use the exact concentration of the final chemical solution 120 to determine the rate at which the final chemical solution is dosed into the water supply line 202. This calibration process can also be automated to account for even slight changes in the concentration of the final chemical solution 120.

The above described systems, devices, processes and methods with respect to FIGS. 1 through 4 can also be represented in the form of a flow chart. For example, FIG. 5 illustrates a method of mixing and dispensing a chemical solution 500. For example, the method can include step 502 of determining a requirement for a final chemical solution, as illustrated in FIG. 5. For example, and as illustrated in FIG. 4, the control unit 138 can receive a signal indicating, or otherwise calculate, an amount of the final chemical solution 120 located in the solution tank 124 and determine if additional amounts of the final chemical solution 120 are needed.

In addition, method 500 can further include the step 504 of adding a known amount of a liquid component to a batch chamber, as illustrated in FIG. 5. For example, as explained with respect to FIGS. 3 and 4, the control unit 138 can activate the liquid valve 160 to add the liquid component 120 to the batch chamber 110. The control unit 138 can deactivate the liquid valve (e.g., close the valve) upon a known amount of the liquid component 120 being deposited into the batch chamber 110.

Furthermore, method 500 can include the step 506 of adding a known amount of a solid component to the batch chamber, as illustrated in FIG. 5. For example, and as illustrated in FIGS. 1, 2 and 4, the control unit can activate the vacuum pump 130 creating an airflow that transports granules 140 of the solid component 104 into the batch chamber 110. The weight measurement device 106 can send a signal to the control unit 138 to allow the control unit to deactivate the vacuum pump once a known amount of the solid component 104 is deposited into the batch chamber 110.

Additionally, method 500 can include step 508 of mixing the liquid component and the solid component to form a final chemical solution, as illustrated in FIG. 5. For example, FIGS. 3 and 4 illustrate that the control unit 138 can activate the motor 182 to spin an agitator 180, which results in a mixing process of the batch solution 118 containing the solid component 104 and the liquid component 116. The final chemical solution 120 is the result of the mixing step.

Moreover, method 500 can include step 510 of dispensing the final chemical solution, as illustrated in FIG. 5. For example, FIGS. 3 and 4 illustrate that the final chemical solution 120 can be dispensed from the solution tank 124 using the pump 128 that is controlled by the control unit 138. As described above with respect to FIGS. 1 through 4, additional steps can be added to method 500 to mix and dispense a chemical solution.

Notwithstanding the various steps and methods that can be achieved, the chemical solution mixing and dispensing system 100 can be built into a self-contained unit to provide ease of manufacturing and ease of installation. For example, FIG. 6 illustrates one example embodiment of the chemical solution mixing and dispensing system 100 that is installed onto a frame 208. The frame 208 can support each device described above, which allows for a central manufacture location for the system 100, as well as a simply plug and play installation.

For example, and as illustrated in FIG. 6, the frame 208 can support the solid component container 102, which is coupled to the batch chamber 110 through the first vacuum tube 108. The second vacuum tube 112 is also coupled to the batch chamber 110 and runs to the vacuum pump 130. In addition, the batch chamber 110 is coupled to the liquid inlet line 114, as is described above. The solution tank 124 is positioned such that the final chemical solution 120 can drain from the batch chamber 110 into the solution tank 124. Finally, the pump 128 is coupled to the solution tank 124 to dispense the final chemical solution 120.

The controller 138 can also be mounted on the frame 208, as illustrated in FIG. 6. Although not shown, each of the communication wires can be efficiently routed between the control unit 138 and the various devices described above. Note, the controller 138 can have a user interface (e.g., input interface, displays, etc.) that an operator can access to control or adjust the chemical solution mixing and dispensing system 100 from the control unit 138. Alternatively, or in addition to, the control unit 138 can be connected to a network such that the control unit, and thus the processes of the control unit, can be monitored and controlled remotely.

The control unit 138 can also have additional external inputs. For example, the control unit 138 can have a remote start input (e.g., contact closure) that allows the chemical solution mixing and dispensing system 100 to be started remotely. In addition, and in the event of a chlorination process, the control unit 138 can be provided with a chlorine residual signal. For example, the chlorine residual signal can be an analog input variable that indicates the chlorine residual in the water flow being treated. Furthermore, the control unit 138 can be provided with a custom signal, such as a SCADA or other system signal that ties the chemical solution mixing and dispensing system 100 into a larger overall system.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes that come within the meaning and range of equivalency of the claims are to be embraced within their scope.

What is claimed is:

1. A system, comprising:
a solid component container that holds a solid component;
a vacuum line having a first end and a second end, the first end of the vacuum line coupled to the solid component container;
a batch chamber coupled to the second end of the vacuum line;
a vacuum pump that when activated creates an airflow from the solid component container through the vacuum line and into the batch chamber, the airflow capable of moving a portion of the solid component from the solid component container to the batch chamber; and
a weight measurement device that measures a change of weight of the solid component located in the solid component container as the airflow moves the portion of the solid component from the solid component container to the batch chamber.

2. The system as recited in claim 1, wherein the solid component is in a granular form.

3. The system as recited in claim 1, further comprising a liquid inlet line coupled to the batch chamber, the liquid inlet line supplying a liquid component to the batch chamber.

4. The system as recited in claim 3, further comprising a liquid valve positioned on the liquid inlet line to control the supply of the liquid component to the batch chamber.

5. The system as recited in claim 4, further comprising a control unit that is programmed to control the vacuum pump to deposit a predetermined amount of the solid component into the batch chamber.

6. The system as recited in claim 5, wherein the control unit is further programmed to control the liquid valve to deposit a predetermined amount of the liquid component into the batch chamber.

7. The system as recited in claim 6, wherein the control unit is in communication with the weight measurement device and controls the vacuum pump based at least in part on the change of weight of the solid component within the solid component container.

8. The system as recited in claim 7, wherein the control unit deactivates the vacuum pump after the change of weight of the solid component is substantially equal to the predetermined amount of the solid component.

9. The system as recited in claim 8, further comprising a flush valve positioned on the vacuum line, the flush valve capable of bypassing the airflow around the solid component container.

10. The system as recited in claim 9, wherein the control unit controls the flush valve to cause the airflow to bypass the solid component container after the change of weight of the solid component substantially equals the predetermined amount of the solid component, but before the control unit deactivates the vacuum pump.

11. A system, comprising:
a solid component dispensing subsystem, comprising:
a solid component container;
a solid component located with the solid component container; and
a vacuum pump that provides an airflow through the solid component container, the airflow capable of moving a portion of the solid component out of the solid component container.

12. The system recited in claim 11, further comprising:
a batch mixing subsystem, comprising:
a liquid inlet line;
a liquid component flowing through the liquid inlet line; and
a batch chamber coupled to the liquid inlet line to allow the liquid component to flow into the batch chamber, the batch chamber also included in the airflow to cause the portion of the solid component to be deposited in the batch chamber.

13. The system recited in claim 12, wherein the batch mixing subsystem further comprises an agitator located within the batch chamber to agitate or otherwise mix the solid component with the liquid component to form a final chemical solution.

14. The system recited in claim 13, further comprising:
a chemical dispensing subsystem, comprising:
a solution tank for containing the final chemical solution; and
a pump for dispensing the final chemical solution.

15. The system recited in claim 14, wherein the pump for dispensing the final chemical solution is coupled to a water supply line and dispenses the final chemical solution into the water supply line.

16. The system recited in claim 15, wherein the solid component contains chlorine and the liquid component is water, and the final chemical solution is a chlorine solution for treating a water supply flowing in the water supply line.

17. A method, comprising:
determining a requirement for an amount of a final chemical solution;
adding a known amount of a liquid component to a batch chamber based on the requirement for a final chemical solution;
adding a known amount of a solid component to the batch chamber; and
mixing the liquid component and solid component to form a final chemical solution.

18. The method recited in claim 17, wherein adding a known amount of a solid component comprises:
activating a vacuum pump to create an airflow;
directing the airflow to move at least a portion of the solid component from a solid component container to the batch chamber.

19. The method recited in claim 18, wherein adding a known amount of the solid component further comprises verifying the known amount of the solid component through a change in weight of a solid component container that holds the solid component.

20. The method recited in claim 19, further comprising dispensing the final chemical solution into an industrial application.
